(19) United States
(12) Patent Application Publication
(10) Pub. No.: US 2019/0275530 A1
(43) Pub. Date: Sep. 12, 2019

(54) Fragmentation Device for a Metal Material Fragmenter

(71) Applicant: Talleres ZB, S.A., Renteria (ES)

(72) Inventor: Mikel Macías Martín, Renteria (ES)

(21) Appl. No.: 16/294,088

(22) Filed: Mar. 6, 2019

(30) Foreign Application Priority Data
Mar. 7, 2018 (ES) U201830306

(51) Int. Cl. B02C 23/02; B02C 19/00

(52) U.S. Cl. CPC B02C 23/02; B02C 19/0062

(57) ABSTRACT

An improved fragmentation device for a metal material fragmenter comprising an inlet chamber configured to receive metal material and a fragmentation chamber that receives the metal material from the inlet chamber is provided. The fragmentation chamber includes a plurality of hammers linked to a rotor and at least one outlet grate with a plurality of through holes for the outlet of fragmented material from the fragmentation chamber, with the additional fragmentation chamber including a recirculation grate that communicates the fragmentation chamber with the inlet chamber, the recirculation grate being located in a position higher than the rotor inside the fragmentation chamber. The additional grate prevents the device from becoming blocked by an excess load inside the same or by an element that cannot be fragmented.

### CROSS-REFERENCE TO RELATED APPLICATIONS

This application claims priority to Spanish Utility Model Application No. U201830306 filed Mar. 7, 2018, the disclosure of which is hereby incorporated by reference in its entirety.

### BACKGROUND OF THE INVENTION

### Object of the Invention

The present disclosure relates to an improved fragmentation device for a metal material fragmenter, that by means of an additional grate, prevents the fragmentation device of the fragmenter from becoming blocked by an excess load inside the same or by an element that cannot be fragmented due to, for example, the hardness thereof. The improved fragmentation device, due to the configuration and design thereof, provides an increase in the production of the fragmenter, a reduction in energy consumption and reduced wear on the consumable parts. The fragmentation device object of the disclosure is applicable in the recycling industry, specifically in the recycling industry of metal material.

### Field of the Invention

A fragmenter, in a very basic form, consists of:
an actuation system (electric or diesel) that is responsible for supplying mechanical power to the fragmentation process, and in turn (depending on the case), supplying the hydraulic and electric power necessary for other systems of the machine, such as the actuation of the supply system, cooling motors, outlet belts, etc.
a supply system that is responsible for supplying the machine with the material to be fragmented, once the material to be fragmented has been placed on the supply system by auxiliary means;
a fragmentation system that is responsible for fragmenting the material and reducing its size, which increases the density of the cited material. This makes it possible inside a fragmentation chamber wherein hammers arranged on a rotor that rotates, strike the material inside the fragmentation chamber, until said material is of a size that enables it to exit from the fragmentation chamber to a removal area, passing through grates with a specific span;
a removal system that is responsible for transporting the fragmented material to the outside, and take it to other processes of the installation.

Currently, the chambers of the fragmenters have one or several material outlets in the form of grates, through which the material exits to the outside of the fragmenters with the desired size. That is, the grates are what establish the different sizes to which the material must be reduced during fragmentation.

If the material introduced into the fragmentation chamber cannot be fragmented due to too much load having been introduced inside or due to the characteristics of the material introduced, the only option that exists to remove it during the production is by means of an expulsion hatch, but the material that exits through this expulsion hatch does not acquire the desired shape or density.

Likewise, if the rotor becomes clogged, the frame must be opened in order to remove the material. This means that the fragmenter must be stopped, which has a significant negative effect on production.

Reducing the outlet material through the expulsion hatch and preventing the option of having to open the frame due to clogging, also causes the addition of having to condition the supply of the fragmenter, as overloading the machine must be controlled at all times. It must be added that, given the type of material processed in this type of application, the supply of the machine does not tend to be very homogeneous, such that there tend to be peak material loads in the supply and, therefore, in the fragmenter chamber. This work regime thus affects the consumption of the motor.

### SUMMARY OF THE INVENTION

In order to reach the objectives and prevent the drawbacks mentioned in the above sections, the present disclosure teaches an improved fragmentation device for a metal material fragmenter comprising an inlet chamber configured to receive metal material and a fragmentation chamber that receives the metal material from the inlet chamber.

The fragmentation chamber comprises a plurality of hammers linked to a rotor and at least one outlet grate with a plurality of through holes for the outlet of fragmented material from the fragmentation chamber.

In the device object of the disclosure, the fragmentation chamber further comprises a recirculation grate that communicates the fragmentation chamber with the inlet chamber, the recirculation chamber being located in a position higher than the rotor inside the fragmentation chamber.

In the improved fragmentation device for a metal material fragmenter object of the disclosure, the recirculation grate comprises a plurality of openings with a larger dimension that of the through holes of the at least one outlet grate.

The range by which the dimensions of the openings of the recirculation grate are greater than the through holes of the outlet grate is between 1.2 and 1.5 times.

In the improved fragmentation device for a metal material fragmenter object of the disclosure, the openings of the recirculation grate have an angle that is aligned with an average direction of strikes of the hammers on the metal material in the fragmentation chamber.

In addition, the openings of the recirculation grate are positioned in line with the hammers of the fragmentation chamber.

In the improved fragmentation device for a metal material fragmenter, the inlet chamber comprises an access hatch configured to swing inwards in the inlet chamber.

The access hatch is joined by means of bearings to a frame of the fragmenter.

Furthermore, the access hatch is joined to lateral arms that in turn house a counter-weight with the ability to move along the length of the lateral arms.

### BRIEF DESCRIPTION OF THE DRAWINGS

To complete the description, and for the purpose of helping to make the characteristics of the disclosure more readily understandable, the present specification is accompanied by a set of figures constituting an integral part of the same, which by way of illustration and not limitation represent the following:

FIG. 1 is a cross-sectional side view of the fragmentation device object of the disclosure.

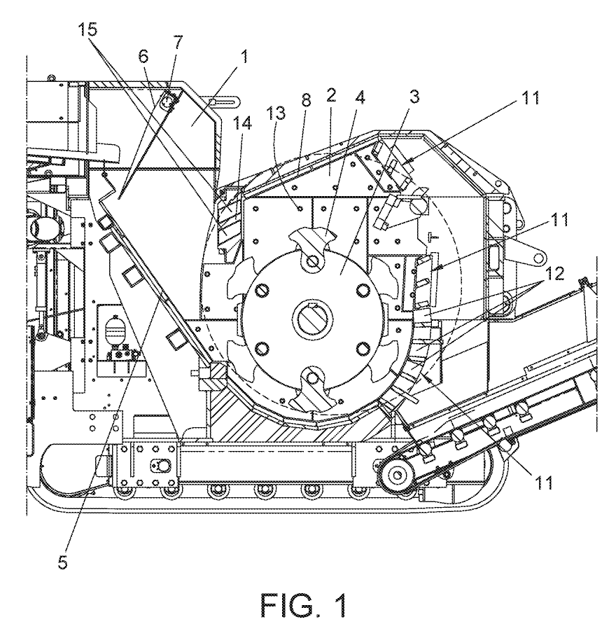

FIG. 2 is a top perspective view of the device object of the disclosure showing the hammers and the recirculation grate.

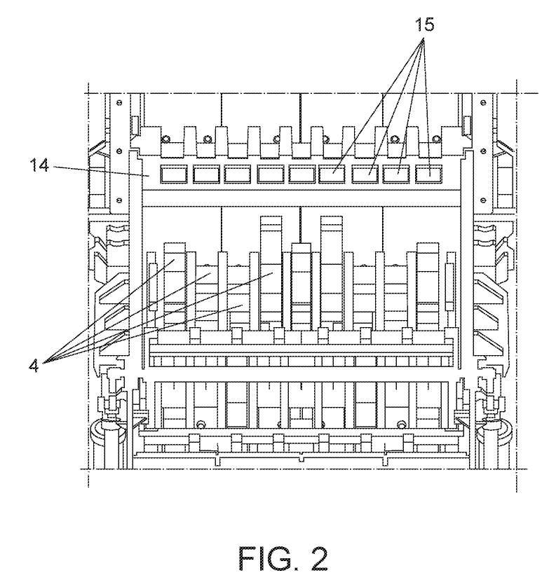

FIG. 3 is a perspective view of the access hatch of the device object of the disclosure.

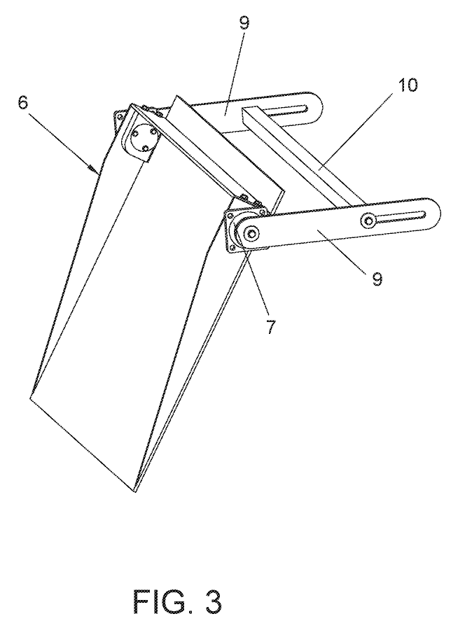

The various numerical references found in the figures correspond to the following elements:

1.—Inlet chamber,

2.—Fragmentation chamber,

3.—Rotor,

4.—Hammers,

5.—Inlet ramp,

6.—Access hatch,

7.—Bearing,

8.—Closure wall,

9.—Lateral arm,

10.—Counter-weight,

11.—Outlet grate,

12.—Through hole.

13.—Fragmentation subchamber,

14.—Recirculation grate, and

15.—Opening.

### DESCRIPTION OF THE INVENTION

As mentioned above, and as can be seen in the figures, the object of the disclosure is an improved fragmentation device comprising an inlet chamber (1) that enables the material to be fragmented to access a fragmentation chamber (2) inside of which a rotor (3) and a plurality of hammers (4) linked to the rotor (3) are located.

The inlet chamber (1) is limited by an inlet ramp (5) that guides the metal material until it enters by gravity into the fragmentation chamber (2), and has an access hatch (6) that swings inwards in the inlet chamber (1) and once the material is located inside the inlet chamber (1), it recovers its position preventing the outlet of the cited material from the inlet chamber (1).

In order for the access hatch (6) to rotate, it is joined by means of bearings (7) to a frame of the fragmenter wherein the fragmentation device object of the disclosure is located. The position of the access hatch (6) is established by gravity, that is it is the access hatch (6) itself that, due to the weight thereof, is located preventing the outlet of material from the inlet chamber (1).

Similarly, the access hatch (6) is joined to lateral arms (9) that in turn house a counter-weight (10) that can move along the length of the lateral arms (9), such that the position of the access hatch (6) can be modified by means of moving the counter-weight (10) along the length of the lateral arms (9).

For the outlet of the fragmented material from inside the fragmentation chamber (2), the device object of the disclosure comprises at least one outlet grate (11) in the perimeter of the fragmentation chamber (2). Specifically in the preferred embodiment of the disclosure, one of the outlet grates (11) is located at the lowest point of the fragmentation chamber (2), another outlet grate (11) is located at an average height of the fragmentation chamber (2) and the third outlet grate (11) in the highest position, at the end of the path travelled by the metal material around the rotor (3) inside the fragmentation chamber (2).

Each outlet grate (11) has a plurality of through holes (12) with a specific dimension, this specific dimension being the size to which the metal material must be reduced in order to exit the fragmentation chamber (2). As such, by means of the outlet grate (11), it is possible to carry out a first classification of the fragmented materials extracted from the fragmentation device, since different outlet grates (11) provide an outlet to different sizes of fragmented elements.

The fragmentation chamber (2) is limited in the upper portion by a closure wall (8), such that inside the fragmentation chamber (2), a fragmentation subchamber (13) is located between the rotor (3) and the closure wall (8). In the normal operation of the fragmentation device object of the disclosure, the metal material that is not fragmented until it reaches a size sufficient to exit through any of the outlet grates (11), is dragged by the hammers (4) linked to the rotor (3) to the fragmentation subchamber (13).

The fragmentation device object of the disclosure comprises a recirculation grate (14) that communicates the fragmentation subchamber (13) with the inlet chamber (1), said recirculation grate (14) has a plurality of openings (15) with a larger dimension that of the through holes (12) of the outlet grates (11), such that the metal material, the size of which has not been reduced sufficiently to exit through the outlet grates (11), passes from the fragmentation subchamber (13) to the inlet chamber (1) in order to return to the fragmentation chamber (2), wherein the hammers (4) crush said material again until the size thereof reduces. The range by which the openings (15) of the recirculation grate is greater than the through holes (12) is comprised between 1.2 and 1.5 times, this range optimising the ratio between the material that is fragmented again and the material that the fragmentation device object of the disclosure produces in a first step by the hammers (4).

The openings (15) of the recirculation grate (14) have a specific orientation since they have an angle that is aligned with the average direction of the strikes of the hammers (4) on the metal material in the fragmentation subchamber (13). This specific orientation of the openings (15) facilitates the passage of the metal material from the fragmentation subchamber (13) to the inlet chamber (1). In addition, in order to contribute to facilitating the passage of the metal material from the fragmentation subchamber (13) to the inlet chamber (1), the openings (15) of the recirculation grate (14) are positioned in line with the hammers (4) of the fragmentation chamber (2), in this way each strike of the hammer (4) on a metal element and the resulting push thereof towards the recirculation grate (14) is better used.

The disclosure is not intended to be limited to the specific embodiment described in this document. Those skilled in the art may develop other embodiments in light of the description made herein.

1. An improved fragmentation device for a metal material fragmenter comprising an inlet chamber configured to receive a metal material and a fragmentation chamber that receives the metal material from the inlet chamber, the fragmentation chamber comprising a plurality of hammers linked to a rotor and at least one outlet grate comprising a plurality of through holes configured to outlet a fragmented material from the fragmentation chamber, wherein the fragmentation chamber further comprises a recirculation grate configured to establish communication between the fragmentation chamber and the inlet chamber, the recirculation grate being located in a position higher than the rotor inside the fragmentation chamber.

2. The improved fragmentation device for a metal material fragmenter according to claim 1, wherein the recirculation grate comprises a plurality of openings, and each opening from the plurality of openings includes a dimension that is larger than a corresponding dimension of each of the through holes from the plurality of through holes of the at least one outlet grate.

3. The improved fragmentation device for a metal material fragmenter according to claim 1, wherein the recirculation grate comprises a plurality of openings, and each opening from the plurality of openings includes a dimension that is 1.2 to 1.5 times larger than a corresponding dimension of each of the through holes from the plurality of through holes.

4. The improved fragmentation device for a metal material fragmenter according to claim 2, wherein each opening from the plurality of openings of the recirculation grate comprises an angle that is aligned with an average direction of strikes of the hammers from the plurality of hammers on the metal material in the fragmentation chamber.

5. The improved fragmentation device for a metal material fragmenter according to claim 2, wherein each opening from the plurality of openings of the recirculation grate is positioned in line with the hammers from the plurality of hammers of the fragmentation chamber.

6. The improved fragmentation device for a metal material fragmenter according to claim 1, wherein the inlet chamber comprises an access hatch configured to swing inwards in the inlet chamber.

7. The improved fragmentation device for a metal material fragmenter according to claim 6, wherein the access hatch is joined by an arrangement comprising at least one bearing to a frame of the fragmenter.

8. The improved fragmentation device for a metal material fragmenter according to claim 6, wherein the access hatch is joined to at least one lateral arm configured to house a counter-weight, the counter-weight configured to move along a length of the at least one lateral arm.
